(19) United States
(12) Patent Application Publication
(10) Pub. No.: US 2008/0051926 A1
(43) Pub. Date: Feb. 28, 2008

(54) Method for Connecting Components by Riveting

(76) Inventor: Thomas Zemp, Pfaffikon-Zurich (CH)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 10/564,847

(22) PCT Filed: Jul. 6, 2004
(86) PCT No.: PCT/JP04/07373

§ 371 Date: Mar. 13, 2006

(30) Foreign Application Priority Data
Jul. 16, 2003 (DE) 103 32 474.7

(51) Int. Cl. B21J 15/28; F16B 19/10; G06F 19/00

(52) U.S. Cl. 700/145; 411/501

(57) ABSTRACT

The invention relates to a method for connecting components (5), whereby at least one rivet (1) penetrates at least one component (5), and a closing head (6) is molded on the rivet (1) or any given molded part (1) by means of a molding machine. According to the invention, prior to the deformation of the closing head (6) on the rivet (1) or the given molded part (1), a rivet projection (U) is determined for the respective determination of the molding parameters, such as the molding course, molding time, and molding force.

The invention relates to a method for connecting components, whereby at least one rivet penetrates at least one component, and a closing head is molded on the rivet or any given molded part by means of a molding machine.

In conventional methods, for positioning a component pair or a component rivet connection the rivet is passed through the component and a rivet projection is determined. If a measured or determined rivet projection lies outside a minimum or maximum range, i.e., a rivet projection range, a consistent riveting result cannot be ensured, and the machine comes to a stop or the rivet connection is declared a reject. In this regard it is disadvantageous that very narrow tolerance ranges must be observed.

It is therefore necessary to use rivets which lie in an exact tolerance range. In addition, the bearing face or the component must likewise be finished or fabricated in very narrow tolerance ranges so that optimum riveting is ensured in the riveting process.

The tolerance ranges are frequently above or below these values, with the result that the riveting process must be stopped, or a large number of rejects occurs in the fabrication process, which is undesirable.

Since the use of rivet connections in large numbers is becoming increasingly common for joining components, rivets are frequently used which are manufactured in automatic lathes, resulting in rather high costs.

However, it is also possible to use rivets which are manufactured by cold forging, for example, which are thus much more economical to manufacture but which, however, have a greater tolerance range as the result of a more optimal manufacturing process. In customary fabrication processes used heretofore, such optimized rivets cannot be used to consistently produce or ensure an exact rivet connection. For example, cold-forged rivets may have a tolerance range of approximately 1 mm. In the above example, however, the projection tolerance of the rivet projection is in the range of approximately 0.3 mm. Since a constant molding course or a constant molding time is preselected in the riveting or molding process, these rivets therefore cannot be used to obtain a required, specified rivet connection.

The object of the present invention is to improve upon a method of the aforementioned type in which economical rivets can be used and a rivet connection can be produced which results in a perfect and tolerable rivet connection, even when the rivet projection is above or below an allowable value.

This object is achieved by the characterizing features of Claims 1 and 2.

In the present invention, it has proven to be particularly advantageous that, for each rivet connection or component pair composed of a rivet and component, a rivet projection on the rivet shaft is precisely determined before the molding process or before deformation. If the rivet projection is within the tolerance range, by use of preselected molding parameters of molding course and molding time the closing head is deformed for a correct rivet connection. However, if the rivet which penetrates the component exceeds the allowable rivet projection, in the method according to the invention compensation is automatically made in the riveting or molding process by determining the actual rivet projection for the respective rivet connection, and the molding course, molding time, and molding force are modified and adjusted so that a perfect riveting operation can still be ensured. The same applies for the opposite case: if the rivet projection actually measured and determined before the molding process is below the minimum limit, i.e., the minimum rivet projection, this is likewise taken into account in the riveting and the molding parameters such as the molding course and molding time. Preferably, after each rivet projection is determined the molding process is automatically respecified, i.e., the parameters thereof are respecified and adjusted, depending on the deviation from the required rivet projection.

In particular, a percentage of the amount by which the rivet projection exceeds or falls below the allowable value is used as a correction factor for the molding process parameters such as molding course, molding force, and molding time.

It is also within the scope of the present invention that to determine the actual rivet projection, measuring elements or, optionally, mechanical scanning devices, are used, one of which scans the base area of the component and the second, usually directly attached to the rivet header, measures the height of the rivet when placed thereon to determine the rivet projection. In the present invention, it is also important that both the scanning devices are situated on a common measuring axis. In this manner, measurements can be made by using only one measuring channel. Furthermore, the measuring results may be calculated in real time in a computing unit.

Overall, by use of the present invention rivets having wide production tolerances may be used to obtain a consistently reliable riveting result. Significant cost savings may thus be realized in the fabrication process by the use of more economical rivets. Furthermore, high accuracy and consistent process and rivet monitoring is ensured during the fabrication process, even for conventional rivets, so that the error rate is minimized or even eliminated in the molding or riveting process.

Further advantages, features, and particulars of the invention result from the following description of preferred exemplary embodiments, and with reference to the drawings, which show the following:

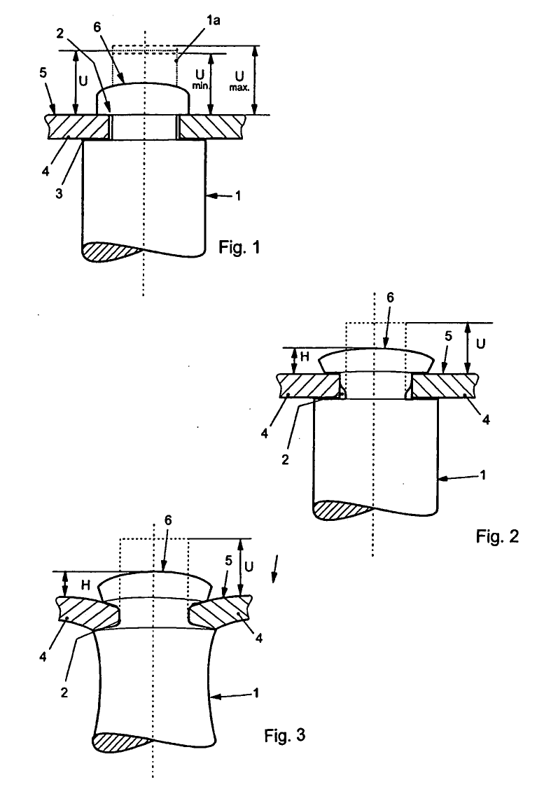

FIG. 1 shows a schematically illustrated view of a rivet which is inserted into an opening of a component, before the molding, in particular, the riveting process;

FIG. 2 shows a schematically illustrated view of a component pair after the molding process, in particular, a correctly shaped closing head;

FIG. 3 shows a schematically illustrated view of a component pair, in particular a rivet and a component, having an incorrect closing head and deformed bearing face;

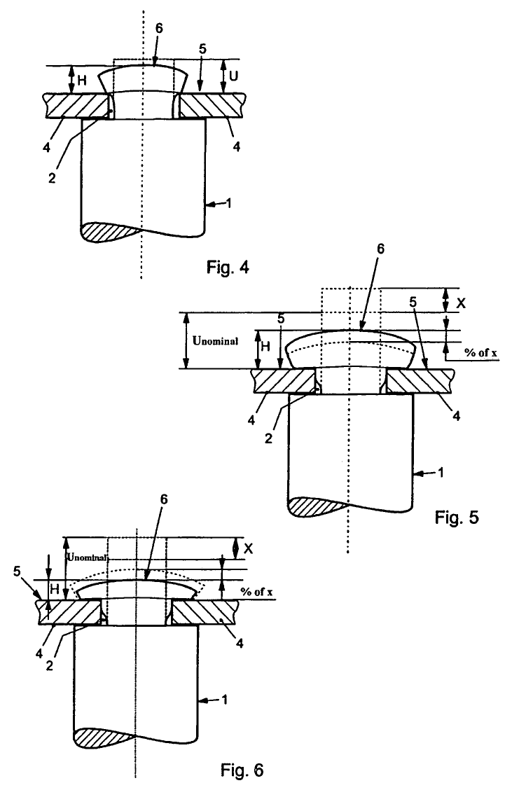

FIG. 4 shows a schematically illustrated view of a defective rivet connection having a rivet projection that is too small, and a faulty closing head;

FIG. 5 shows a schematically illustrated view of a correct closing head of a rivet connection, having a rivet projection that is too large; and

FIG. 6 shows a schematically illustrated view of a rivet connection having a rivet projection that is too small, but with a correct closing head and correct rivet connection.

According to FIG. 1, to produce a rivet connection or component pair a rivet 1 is inserted through an opening 2 until a shoulder 3 of the rivet 1 contacts a bearing face 4 of the component 5. A cylindrical rivet shaft 1 or a component 1 to be shaped penetrates the opening 2 and projects from the component 5 in a rivet projection U. After the deformation, the rivet shaft 1a, i.e., the component to be shaped, is deformed into a rivet head 6. It is expressly noted that a projection of a component which is to be connected to another component by molding is also understood to be a rivet 1. For the sake of simplicity, in the present patent application the term “rivet” is used for the projection of a component.

Depending on the accuracy of fabrication and the tolerance of the rivet 1, for the molding, in particular, riveting, process it is important that the rivet projection U moves in a tolerance range of a conventional fabrication or riveting process. In this regard, for a conventional molding or riveting process a minimum rivet projection Uₘᵢₙ or a maximum rivet projection Umax may be predefined to set fixed values for the molding parameters, such as the molding force, molding speed, molding course, and molding time, to achieve a consistent riveting result at this specified machine setting which is still within the allowable tolerance range. Component pairs or rivets having a rivet projection U which respectively falls below or exceeds the rivet projection Uₘᵢₙ or Uₘₐₓ are excluded as rejects.

In a molding process, in particular a riveting process, using for example a header of a riveter (not illustrated here), in particular as illustrated in FIG. 2, the closing head 6 is shaped so that a closing head height H is formed. The closing head 6 is thicker in the area of the bearing face 4. The closing head 6 also forms a sufficient overlap beyond the bearing face 4 or opening 2 or borehole, there being no significant deformation of the component 5 detectable in the region of the bearing face. This closing head 6 is correctly shaped.

In the exemplary embodiment of the present invention according to FIG. 3, the closing head 6 is not correctly shaped, since the bearing face 4 is deformed. This may be due to the fact that for a conventional riveting or molding process the rivet projection U is too large, and an allowable rivet projection Uₘₐₓ has been exceeded. To achieve a constant closing head height H, when the rivet projection U is too high the component 5 or sheet, in particular the bearing face 4 thereof, becomes warped or distended, and the shoulder 3 of the rivet 1 is compressed. The rivet connection is not correct.

A second possibility for error is that when a rivet projection is less than a rivet projection U, i.e., a rivet projection Uₘᵢₙ, as shown in particular in the exemplary embodiment according to FIG. 4, to achieve a correct closing head 6 at constant closing head height H too little material is present for the closing head 6 during molding, so that there is insufficient overlap of the closing head 6 beyond the bearing face 4 or opening 2, and in addition it is not ensured that the rivet 1 is compressed or pressed within the opening 2, with the result that an adequate rivet connection is not produced.

The exemplary embodiment of the present invention according to FIG. 5 shows that in carrying out the method according to the invention by actually determining the rivet projection for each rivet or for each component pair before riveting by appropriate scanning or measuring devices, which can be attached to the header or spindle of a riveter, an exact rivet projection U is first determined before riveting is begun.

Then, in the method according to the present invention the rivet projection is used to automatically adjust or adapt in the molding machine or riveter the molding course, molding time, molding force, etc. over the respective rivet connection, or for the rivet projection that is actually present, to achieve a specified and correct rivet connection.

If, for example, the rivet projection U is too large by a value X, as shown in particular in FIG. 5, the shaping machine or riveter sets a new closing head height H according to a specified percentage of the error X by which the rivet projection U is too large; i.e., riveting is performed to a depth that is reduced by a selectable percentage X, compared to a conventional method. This results in a multifold increase in the volume of the rivet projection, which is located in the higher closing head space. This ensures that the function and correct riveting are maintained. In other words, a rivet can be used which has any given rivet projection that exceeds the maximum rivet projection Uₘₐₓ to ensure and carry out a perfect riveting operation.

However, it is assumed that the rivet projection U actually present for the respective rivet connection is accurately determined, and, based on the deviation from the target value of the predetermined rivet projection, the riveting process is automatically modified, which affects molding parameters such as molding course, molding time, molding force, etc.

The exemplary embodiment of the present invention according to FIG. 6 shows that the rivet projection U is too small by a value X, whereby, after determining the actual rivet projection U, the molding machine, in particular the riveter, then sets a new closing head height H which has been reduced by a specified percentage of the value, i.e., the error, X. In other words, riveting is performed to a depth that is greater by a given percentage which depends on the value X of the too small or too low rivet projection U. Likewise, the rivet projection U, i.e., the actual rivet projection, is determined and is automatically taken into account to set a new closing head height to be traversed or riveted, with a corresponding automatic adjustment of the respective molding time and molding course or the riveting time and riveting course. This ensures that when the rivet projection is too small and is less than a rivet projection U a correct rivet connection can still be produced, so that the closing head has sufficient overlap beyond the borehole or perforation without deforming or damaging the component or bearing face. The operating mode is maintained with correct riveting.

The present invention has the advantage that even rivets outside the tolerance range for producing a correct rivet connection can be used. As a result, significantly more economical rivets can be used for the molding or riveting process. The error rate is reduced, and the rivet connection is optimized and improved, thereby likewise saving on fabrication costs.

### LIST OF REFERENCE NUMBERS

| | |
|---|---|
| 1 | Rivet |
| 2 | Opening |
| 3 | Shoulder |
| 4 | Bearing face |
| 5 | Component |
| 6 | Closing head |
| 7 | |
| 8 | |
| 9 | |
| 10 | |
| 11 | |
| 12 | |
| 13 | |
| 14 | |
| 15 | |
| 16 | |
| 17 | |
| 18 | |
| 19 | |
| 20 | |
| 21 | |
| 22 | |
| 23 | |
| 24 | |
| 25 | |
| 26 | |
| 27 | |
| 28 | |
| 29 | |
| 30 | |
| 31 | |
| 32 | |
| 33 | |
| 34 | |
| 35 | |
| 36 | |
| 37 | |
| 38 | |
| 39 | |
| 40 | |
| 41 | |
| 42 | |
| 43 | |
| 44 | |
| 45 | |
| 46 | |
| 47 | |
| 48 | |
| 49 | |
| 50 | |
| 51 | |
| 52 | |
| 53 | |
| 54 | |
| 55 | |
| 56 | |
| 57 | |
| 58 | |
| 59 | |
| 60 | |
| 61 | |
| 62 | |
| 63 | |
| 64 | |
| 65 | |
| 66 | |
| 67 | |
| 68 | |
| 69 | |
| 70 | |
| 71 | |
| 72 | |
| 73 | |
| 74 | |
| 75 | |
| 76 | |
| 77 | |
| 78 | |
| 79 | |
| U | Rivet projection |
| Uₘᵢₙ | Rivet projection |
| Uₘₐₓ | Rivet projection |
| H | Closing head height |
| X | Value |

1-9. (canceled)

10. A method for connecting components, whereby at least one rivet penetrates at least one component, and a closing head is molded on the rivet or any given molded part by means of a molding machine, comprising, prior to the deformation of the closing head on the rivet or the given molded part, determining a rivet projection (U) for the respective determination of at least one molding parameter wherein the rivet projection (U) is calculated in a computing unit from at least one measured value from at least one measuring element, and after determining the rivet projection (U), a correction factor for the molding process is recalculated in the computing unit for each successive riveting operation.

11. The method of claim 10, wherein the molding parameter comprises at least one parameter selected from a molding course, a molding time, and a molding force.

12. The method of claim 10, wherein the correction factor is for correcting the at least one riveting process parameter for determining at least one of the molding course, molding time, and molding force.

13. A method for connecting components, whereby at least one rivet penetrates at least one component, and a closing head is molded on the rivet or any given molded part by means of a molding machine, comprising, prior to the deformation of the closing head or the given molded part, determining the rivet projection (U), and automatically compensating for deviations of the rivet projection (U) from an allowable value by automatic adjustment of the process variables, a minimum rivet projection Uₘᵢₙ or a maximum rivet projection Uₘₐₓ being predefined to produce a tolerance range for the rivet projection U, whereby the rivets which respectively fall below or exceed the rivet projection Uₘᵢₙ or Uₘₐₓ are excluded as rejects.

14. The method according to claim 13, wherein to measure the rivet projection, at least one measuring element is used, the at least one measuring element being a rivet header or being attached thereto.

15. The method of claim 14, wherein the at least one measuring device is a scanning device.

16. The method according to claim 13, wherein the rivet projection (U) is calculated by the computing unit in real time.

17. The method according to claim 13, wherein first and second measuring elements are used, which are situated on a common measuring axis, the first and second measuring elements being connected to a rivet spindle which supports the rivet header and traverses the riveting stroke.

18. The method according to claim 17, wherein the first and second measuring elements are first and second scanning devices, and wherein the second scanning device transmits a signal to the computing unit and the measured value is filed and stored on the measuring axis of the first scanning device.

19. The method according to claim 17, wherein for the rivet projection (U) which is determined from two measured values by use of the first and second measuring elements, the same measuring axis need not correspond to the actual dimensions of the work piece or the value to be ascertained, but, rather, may be offset with respect to the nominal value that is programmed or represented.

20. The method according to claim 13, wherein after the projection (U) of the determined component pair is determined, compensation and adjustment is made for the start of riveting in addition to a molding course and molding time, depending on the change in the rivet projection with respect to the actual value for each riveting operation to be performed.

21. The method according to claim 13, wherein before each molding process, compensation is automatically made for component pairs, and the process parameters for the riveter and/or molding machine are automatically adjusted with respect to the molding operation to be performed, the molding time, and the molding course, depending on the deviation of the value (X) from the allowable and specified rivet projection (U).

22. The method of claim 21, wherein the molding process is a riveting process.

23. The method of claim 21, wherein compensation is automatically made for the determination of the rivet projection.

24. The method of claim 13, wherein the rivets are component pairs.

25. The method of claim 13, wherein the process variables include at least one process variable selected from molding time or molding course.
